(19) United States
(12) Patent Application Publication
(10) Pub. No.: US 2003/0230359 A1
(43) Pub. Date: Dec. 18, 2003

(54) Mortise and tenon adapters for dovetail jigs

(76) Inventor: Charles W. Schroeder, Estes Park, CO (US)

Correspondence Address: ANCEL W. LEWIS, JR., 425 WEST MULBERRY, SUITE 101, FORT COLLINS, CO, 80521, US

(21) Appl. No.: 10/461,846

(22) Filed: Jun. 13, 2003

Related U.S. Application Data
(60) Provisional application No. 60/389,203, filed on Jun. 17, 2002.

(51) Int. Cl. B27C 5/00; B27M 1/08; B27M 3/00; B27C 9/00

(52) U.S. Cl. 144/144.1; 144/372

(57) ABSTRACT

A mortise and tenon joint adapter system for use with a dovetail jig base and a router has a template support, a mortise shelf, mortise and tenon templates, and a layout guide. The template support mounts on the jig base and the templates mount on the template support. The mortise shelf mounts on the jig base, is vertically adjustable and clamps laterally extending mortise work pieces. Mortising and tenoning slots on the templates provide two sided guidance and full support for the router. Movable stops in the slots provide length adjustability for mortises and tenons. The layout guide assures precise layout of mortises and tenons created with the templates.

This application claims the benefit under 35 U.S.C. § 119(e) of the U.S. provisional patent application No. 60/389,203 filed Jun. 17, 2002.

### TECHNICAL FIELD

The present invention relates to woodworking tools and more particularly to a system for making mortise and tenon joints using the base of a dovetail jig.

### BACKGROUND ART

Relatively inexpensive jigs have been designed to produce dovetail joints and finger joints, with a powered router, to joint board ends. Generally such jigs have a base and a finger template. The base has a top surface with a top hold down bar and a front surface with a front hold down bar. For half-blind dovetail joints, the pin board is clamped with the top hold down bar onto the top surface of the base with the end flush with the front surface, and the tail board is offset laterally from the pin board and clamped with the front hold down bar onto the front surface of the base with the end flush with top surface of the pin board.

The finger template extends over the pin board, and has legs that extend down on either side of the pin board to mount on the base. The finger template is vertically adjustable to accommodate different thicknesses of pin boards. The finger template has a plurality of spaced, forwardly projecting fingers. A router sits on the fingers and, with a guide bushing and an upwardly tapering, dovetail bit, cuts the sockets and tails at the same time, with the guide bushing following the fingers of the finger template. The width of the pin and tail boards with such jigs is limited by the width of the front and top hold down bars, and by the distance between the legs of the finger template. U.S. Pat. No. 2,764,191 to Hartmann discloses such a dovetail jig for cutting sockets and tails for a dovetail joint at the same time.

There are many variations to mortise and tenon joints. The mortise is an elongated aperture in a first workpiece with the tenon being cut into the end of a second workpiece to fit into the mortise. A mortise that extends through the first workpiece is known as a “through” mortise while a mortise that does not extend through is “stub” or “blind”. Mortise and tenon joints are used in frame and panel casework, rail and stile door construction, and leg and apron joints for furniture. Mortises have been made with a hammer and chisel, a drill and clean up with a chisel, a mortising machine, and a multi-router machine. Tenons have been made with hand saws, power saws, and multi-router machines. Industrial machines are also available for making mortises and tenons.

A finger template is known for making mortise and tenon joints with the above described jig base. However, this mortise and tenon template has the above described width limitations. This finger template can only make mortise and tenon joints to mount shelves in the sides of cabinets, and is not suitable for making mortise and tenon joints for other furniture and cabinet construction. The guide bushing contacts the fingers on only one side with this finger template, making straight cuts difficult. If a forward shoulder, as well as the side shoulders, is to be cut for a tenon, the guide bushing must move across the forward finger ends. The router is then only partially supported and can tip, creating an unstable and potentially hazardous condition. U.S. Pat. No. 4,428,408 to Grisley discloses a dovetailing jig, including a finger template for making mortise and tenon joints, that is subject to these same limitations.

### DISCLOSURE OF THE INVENTION

A mortise and tenon joint adapter system for use with a jig base and a router includes a template support, a mortise shelf, a mortise template, a tenon template and a layout guide. The template support mounts on the top surface of the jig base and is secured with the jig base top hold down bar. The mortise shelf is secured to the jig base front surface by the jig base front hold down bar, and is vertically adjustable. The mortise shelf includes a sliding clamp and shelf hold down bars to secure a laterally extending mortise workpiece. The mortise and tenon templates alternately mount on the template support and are adjustable forwardly and rearwardly. Mortising slots and tenoning slots on the mortise and tenon templates, respectively, provide two sided guidance for a guide bushing on the router, and movable stops in the mortising and tenoning template provide length adjustment for mortises and tenons. The layout guides provides precise layout for mortises and tenons, and compensates for the difference between the size of the guide bushing and the size of the router bit.

### BRIEF DESCRIPTION OF THE DRAWINGS

Details of this invention are described in connection with the accompanying drawings that bear similar reference numerals in which:

FIG. 1 is a perspective view of a mortise and tenon system embodying features of the present invention, configured in the mortise mode.

FIG. 2 is a perspective view of the mortise and tenon system of FIG. 1, configured in the tenon mode.

FIG. 3 is a perspective view of the template support of the mortise and tenon system of FIG. 1.

FIG. 4 a top plan view of a mortise shelf for the mortise and tenon system of FIG. 1.

FIG. 5 is a sectional view taken along line 5-5 of FIG. 4.

FIG. 6 is a sectional view taken along line 6-6 of FIG. 4.

FIG. 7 a top plan view of a mortise template for the mortise and tenon system of FIG. 1.

FIG. 8 is a sectional view taken along line 8-8 of FIG. 7.

FIG. 9 is a sectional view taken along line 9-9 of FIG. 7.

FIG. 10 is a top plan view of a tenon template for the mortise and tenon system of FIG. 1.

FIG. 11 is a top plan view of a layout guide for the mortise and tenon system of FIG. 1.

FIG. 12 is a top plan view of a combined mortise and tenon template for the mortise and tenon system of FIG. 1.

FIG. 13 is a perspective view of a mortise and tenon created with the mortise and tenon system of FIG. 1.

### DETAILED DESCRIPTION OF THE INVENTION

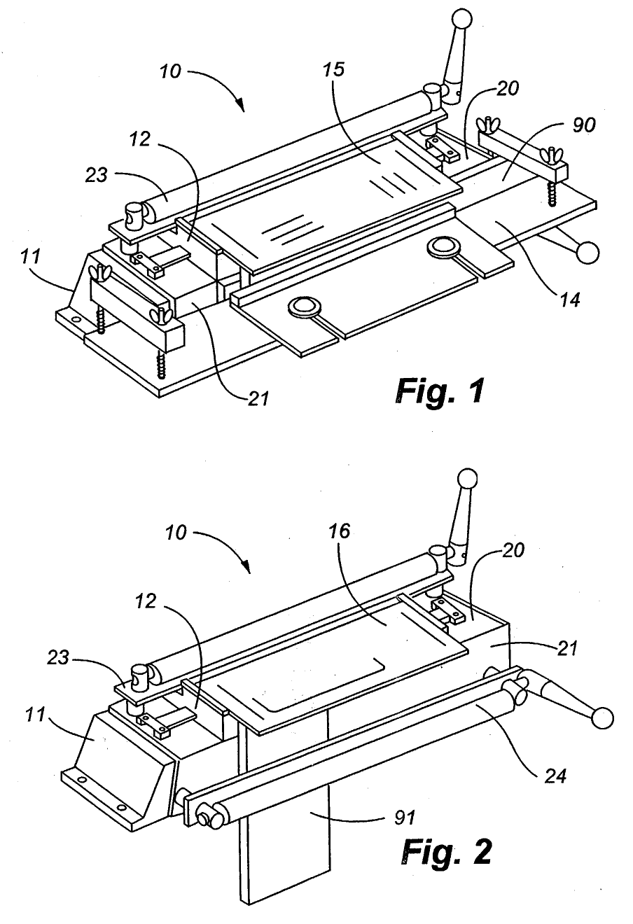

Referring now to FIGS. 1, 2 and 11, a mortise and tenon joint adapter system 10, embodying features of the present invention, for use with a jig base 11 includes a template support 12, a mortise shelf 14, a mortise template 15, a tenon template 16 and a layout guide 17. The jig base 11 suitable for use with the system 10 has a substantially flat, horizontal top surface 20 and a substantially flat, vertical front surface 21. A top hold down bar 23 is spaced above and extends laterally across the top surface 20, and a front hold down bar 24 is spaced in front of and extends laterally across the front surface 21. The top and front hold down bars 23 and 24 are secured to the top and front surfaces 20 and 21, respectively, at opposite ends by cam action clamps, threaded studs with wings nuts, or other suitable means. The jig base 11 is generally available commercially with a dovetail finger template or other template that is removed when the jig base 11 is used with the present invention.

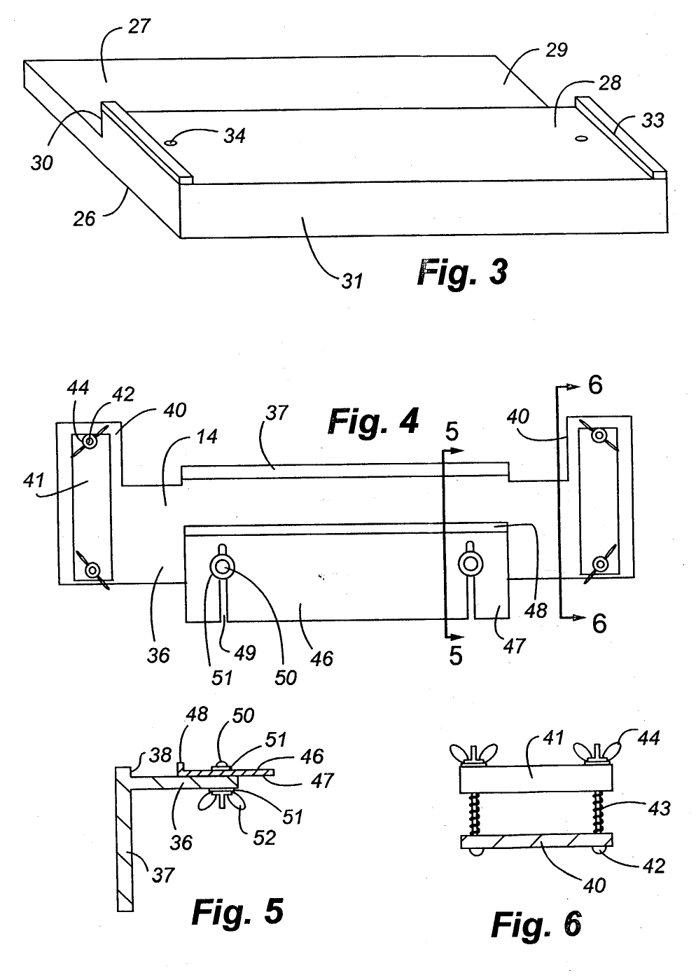

The template support 12, shown in FIG. 3, has a substantially rectangular shape with a flat bottom face 26 and a spaced top face 27. The top face 27 includes rectangular, flat front portion 28, a rectangular, flat rear portion 29 that is spaced downwardly from the front portion 28, and a transverse step face 30 that extends between the front and rear portions 28 and 29. A front face 31 extends between the bottom face 26 and the front portion 28 of the top face 27. Two spaced, elongated template guides 33 mount on the front portion 28 of the top face 27, extending perpendicular to the front face 31. Two vertical, spaced, threaded template securing apertures 34 are provided in the front portion 28 of the top face 27, between the template guides 33 and preferably aligned parallel to the front face 31. The template support 12 mounts on the jig base 11 with the bottom face 26 of the template support 12 on the top surface 20 of the jig base 11, and the top hold down bar 23 extending over the rear portion 29 of the top face 27 of the template support 12. Preferably, the front face 31 of the template support 12 is flush with the front surface 21 of the jig base 11.

Referring to FIGS. 4, 5 and 6, the mortise shelf 14 include a flat, elongated shelf portion 36 and a support portion 37 that is attached to one of the longer edges of the shelf portion 36 and extends perpendicular to the shelf portion 36. The support portion 37 is sized and shaped to mount on the front surface 21 of the jig base 11 with the front hold down bar 24 clamping the support portion 37 under the shelf portion 36. The support portion 37 includes a raised portion 38 that extends above the shelf portion 36. The mortise shelf 14 is vertically adjustable, and is adjusted by loosening the front hold down bar 24, moving the support portion 37 up or down relative to the front surface 21 of the jig base 11, and then retightening the front hold down bar 24.

The shelf portion 36 has spaced, opposed end sections 40 that extend laterally beyond the ends of the jig base 11 and rearwardly beyond the front surface 21 of the jig base 11. A shelf hold down bar 41 in each end section 40 extends perpendicular to the front surface 21 and is secured by two spaced threaded bolts 42 that extend upwardly through the respective end section 40, through springs 43, through opposite ends of the shelf hold down bar 41, and into wing nuts 44.

A sliding clamp 46 has a laterally elongated, flat, horizontal base portion 47 and a upwardly projecting raised portion 48 along the rearward edge of the base portion 47. Two spaced clamp slots 49 extend rearwardly from the front edge of the base portion 47, perpendicular to the raised portion 48. The sliding clamp 46 is secured to the top of the shelf portion 36 of the mortise shelf 14, with the raised portion 48 opposite the raised section 38 of the support portion 37 of the mortise shelf 14, by two threaded bolts 50 that each extend downwardly through a washer 51, one of the clamp slots 49, the shelf portion 36 and another washer 51 with a wing nut 52 being threaded onto the bolt 50. The clamp slots 49 provide forward and rearward adjustability for the sliding clamp 46.

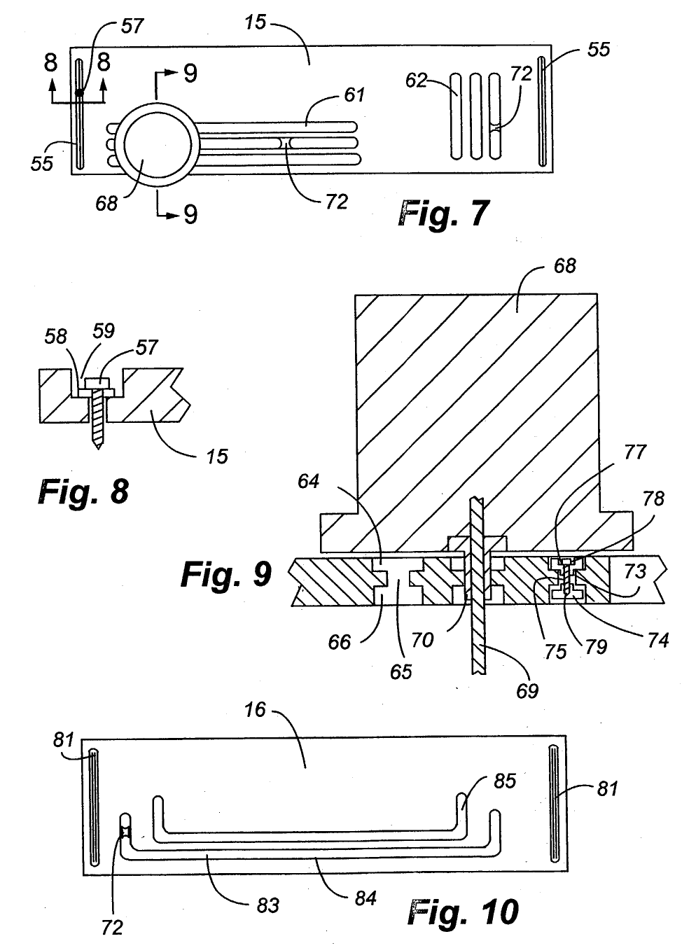

The mortise template 15, as shown in FIGS. 7, 8 and 9, is a flat rectangular plate sized and shaped to mount on the front portion 28 of the top face 27 of the template support 12 between the template guides 33. Preferably the mortise template 15 is at least as thick as the template guides 33. Two elongated, spaced mortise template support slots 55 through the mortise template 15 extend parallel to the template guides 33 with each being aligned with one of the template support apertures 34. A machine screw 57, with a washer 58, extends through each mortise template support slot 55 and into a template support aperture 34. The mortise template support slots 55 each have a widened upper channel 59 sized and shaped to receive the head of the machine screw 57 and the washer 58 so that the top of the machine screw 57 is below the top of the mortise template 15 when the machine screw 57 is tightened in the template support aperture 34. The mortise template support slots 55 provide forward and rearward adjustability for the mortise template 15.

The mortise template 15 includes a plurality of spaced first mortising slots 61 perpendicular to the template guides 33 and a plurality of second mortising slots 62 parallel to the template guides 33. Each of the first and second mortising slots 61 and 62 has an upwardly opening upper channel 64 connected to a downwardly opening lower channel 65 by a narrower intermediate passage 66. The router 68 used to route mortises and tenons is a plunge router, and has a downwardly extending bit 69 and a bushing guide 70 around the upper part of the bit 69. The width of the intermediate passage 66 is marginally wider than the guide bushing 70 to provide two sided guidance of the guide bushing 70 and exact positioning of the bit 69.

Movable stops 72 include an upper piece 73 sized to fit into the upper channel 64, a lower piece 74 sized to fit into the lower channel 65, and a screw 75. The upper piece 73 has an unthreaded upper piece hole 77 and an upwardly opening upper piece recess 78, and the lower piece 74 has a threaded lower piece hole 79. A movable stop 72 is assembled into a first or second mortising slot 61 or 62 with the upper piece 73 in the upper channel 64 and the lower piece 74 in the lower channel 65. The screw 75 extends through the upper piece hole 77 and the intermediate passage 66, and threads into the lower piece hole 79, with the top of the screw 75 in the upper piece recess 78 and below the top of the mortise template 15.

The tenon template 16, as shown in FIG. 10 is a flat rectangular plate sized and shaped to mount on the front portion 28 of the top face 27 of the template support 12 between the template guides 33. Preferably the tenon template 16 is at least as thick as the template guides 33. Two elongated, spaced tenon template support slots 81 through the tenon template 16 extend parallel to the template guides 33 with each being aligned with one of the template support apertures 34. The tenon template support slots 81 are sized, shaped and spaced the same as the mortise template support slots 55 shown in FIG. 8. The tenon template 16 is secured to the template support 12 with machine screws 57 and washers 58, in the same manner as the mortise template 15. The tenon template support slots 81 provide forward and rearward adjustability for the tenon template 16.

The tenon template 16 includes a plurality of spaced tenoning slots 83, each having an elongated lateral section 84 extending perpendicular to the template guides 33 and two end sections 85 that extend rearwardly from opposite ends of the lateral section 84. The size and shape of each tenoning slot 83 is the same as the first and second mortising slots 61 and 62, with the tenoning slot 83 receiving the movable stops 72 and guiding the bit 69 and guide bushing 70 in the same manner as the first and second mortising slots 61 and 62.

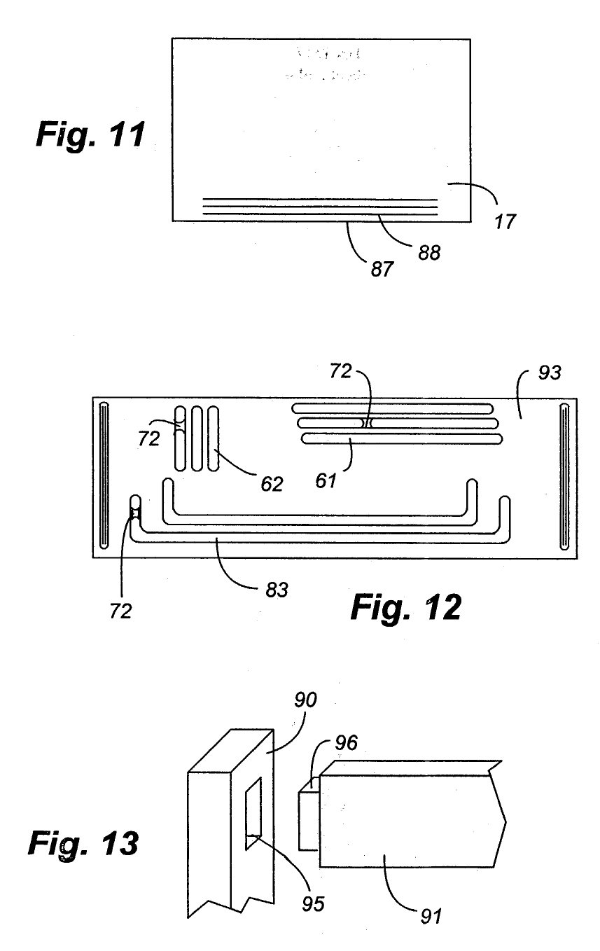

Referring to FIG. 11, the layout guide 17 is a flat piece of transparent material such as plastic. The layout guide has a straight front edge 87 and a plurality of precisely spaced guide lines 88 parallel to the front edge 87. The distance from the front face 87 to the guide lines 88 is preferably the radius of the guide bushing and the difference between the radius of guide bushing 70 and the radius of the router bit 69, for different sizes of bit 69 and/or bushing guide 70.

Referring again to FIG. 1, the mortise for the mortise and tenon joint is created with the template support 12 mounted on the top surface 20 of the jig base 11 and secured by the top hold down bar 23, the mortise template 15 mounted on the template support 12, and the mortise shelf 14 mounted on the front surface 21 of the jig base 11 and secured by the front hold down bar 24. The centerline and endpoints of the desired mortise are laid out on the first workpiece 90, and, using the layout guide, the endpoints are adjusted outward to compensate for the difference between the radius of guide bushing 70 and the radius of the router bit 69. The first workpiece 90 is mounted on the mortise shelf 14, and secured with one of the shelf hold down bars 41 and with the sliding clamp 46. The mortise shelf 14 is raised so that the top of the first workpiece 90 contacts the bottom of the mortise template 15, the mortise template 15 is adjusted so that the selected first or second mortising slot 61 or 62 is centered on the centerline of the first workpiece 90, and movable stops 72 are adjusted to the adjusted endpoints on the first workpiece 90. The router 68 is adjusted for depth and placed over the selected first or second mortising slot 61 or 62, and the mortise is routed using normal plunge router techniques.

Referring again to FIG. 2, the tenon for the mortise and tenon joint is created with the template support 12 mounted on the top surface 20 of the jig base 11 and secured by the top hold down bar 23, and the tenon template 16 mounted on the template support 12. The dimensions of the desired tenon are laid out on the second workpiece 91, and, using the layout guide, all four sides are adjusted inward to compensate for the difference between the radius of guide bushing 70 and the radius of the router bit 69. The second workpiece 91 is mounted on the front surface 21 of the jig base 11 and secured with the front hold down bar 24, with the top of the second workpiece 91 contacting the bottom of the tenon template 16. The tenon template 16 and the second workpiece 91 are adjusted so that the selected tenoning slot 83 is aligned with the adjusted dimensions for two sides of the desired tenon. The movable stop 72 is adjusted to prevent the router bit 69 from contacting the template support 12 or the jig base 11. Two sides of the tenon are routed. The second workpiece 91 is released, rotated 180 degrees, adjusted, and the other two sides of the tenon are routed.

As shown in FIG. 12, the mortise and tenon templates 15 and 16 can alternatively be combined into a single combined template 93, having first and second mortising slots 61 and 62, and tenoning slots 83. As an example and not a limitation, such a template could be used for routing a mortise and then rotated 180 degrees for routing the tenon. Multiple mortise templates 15 and tenon templates 16, with different layouts and different slot sizes, may be provided. The multiple parallel first mortising slots 61 and second mortising slots 62 shown are provided for multiple mortise applications. The mortise and tenon templates 15 and 16, with the first and second mortising slots 61 and 62, and the tenoning slots 83, firmly support the router 68, providing a safer jig. The first and second mortising slots 61 and 62, and the tenoning slots 83 provide two sided guidance for the guide bushing 70, constraining the guide bushing 70 for easier and more accurate routing of mortises and tenons.

FIG. 13 shows a mortise 95 in the first workpiece 90 and a tenon 96 in the second workpiece 91 made with the system of the present invention. The present invention provides apparatus for making furniture and cabinet mortise and tenon joints using existing dovetail jigs. The higher front portion 28 of the top face 27 of the template support 12 and the vertically adjustable mortise shelf 14 together allow creation of mortises in thicker work pieces than prior jigs. The shelf hold down bars 41 and sliding clamp 46 of the mortise shelf 14 form a means for clamping a laterally extending mortise workpiece and can secure a long workpiece, such as a table leg, for routing a mortise. The movable stops 72 provide accurate adjustment of the length of mortises and tenons.

Although the present invention has been described with a certain degree of particularity, it is understood that the present disclosure has been made by way of example and that changes in details of structure may be made without departing from the spirit thereof.

What is claimed is:

1. A mortise and tenon joint adapter system for making mortises and tenons in work pieces in combination with a jig base having a base top surface, an abutting base front surface, a top hold down bar and a front hold down bar and a router having a bit and a guide bushing, said system comprising:
a template support adapted to mount on said base top surface, and including a top face having a horizontal rear portion and an upwardly spaced, horizontal front portion, said rear portion being secured by said top hold down bar, a mortise shelf including a vertical support portion and a horizontal shelf portion extending forwardly from said support portion, said support portion being adapted to mount on said base front surface with vertical adjustability and secured by said front hold down bar under said shelf portion, said mortise shelf including means for clamping a laterally extending mortise workpiece, and at least one template mountable on said front portion of said top face of said template support, and including a mortising slot and a tenoning slot with each said mortising and tenoning slot being sized to provide two sided guidance of said guide bushing.

2. The system as set forth in claim 1 wherein each said template is adjustable forwardly and rearwardly relative to said template support.

3. The system as set forth in claim 2 wherein said front portion of said top face of said template support includes two laterally spaced, upwardly projecting template guides that extend perpendicular to said base front surface, and two laterally spaced threaded template support apertures between said template guides, and
each said template is sized to fit between said template guides, and includes a pair of spaced template support slots parallel to said template guides that are located one each over a said template support aperture and a pair of threaded fasteners that each extend through a said template support slot and into a said template support aperture.

4. The system as set forth in claim 1 wherein said at least one template includes a plurality of mortising slots and a plurality of tenoning slots.

5. The system as set forth in claim 4 wherein said at least one template includes a mortise template having said mortising slots and a tenoning template having said tenoning slots.

6. The system as set forth in claim 1 wherein said template includes a plurality of first mortising slots parallel to said base front surface and a plurality of second mortising slots perpendicular to said first mortising slots.

7. The system as set forth in claim 1
wherein each said mortising slot and tenoning slot has an upwardly opening upper channel, a downwardly opening lower channel and an intermediate passage connecting said upper and lower channels, and
said template includes at least one slidably adjustable movable stop having an upper piece sized and shaped to fit into a said upper channel, a lower piece sized and shaped to fit into a said lower channel, and a screw connecting said upper and lower pieces.

8. The system as set forth in claim 1 wherein said tenoning slot includes a laterally extending lateral section and a pair of spaced end sections that extend rearwardly from opposite ends of said lateral section.

9. The system as set forth in claim 1 wherein said shelf portion of said mortise shelf includes a pair of spaced, opposed end sections that extend laterally beyond jig base, said support portion includes a raised section that extends above said shelf portion, and said means for clamping includes a shelf hold down bar on each said end section and a sliding clamp opposite said raised section, said sliding clamp being forwardly and rearwardly adjustable, and having a raised portion that, in combination with said raised section of said support portion, clamps said mortise workpiece.

10. The system as set forth in claim 1 including a layout guide having a front edge and a plurality of spaced guide lines at selected precise distances from and parallel to said front edge, with said distances being selected as the radius of said guide bushing and the difference between the radius of said guide bushing and the radius of said bit, for different said guide bushing and bit sizes.

11. A mortise and tenon joint adapter system for making mortises and tenons in work pieces in combination with a jig base having a base top surface, an abutting base front surface, a top hold down bar and a front hold down bar and a router having a bit and a guide bushing, said system comprising:
a template support adapted to mount on said base top surface, and including a top face having a horizontal rear portion and an upwardly spaced, horizontal front portion, with said rear portion being secured by said top hold down bar, said front portion including two laterally spaced, upwardly projecting template guides that extend perpendicular to said base front surface and two laterally spaced threaded template support apertures between said template guides,
a mortise shelf including a vertical support portion and a horizontal shelf portion extending forwardly from said support portion, said support portion being adapted to mount on said base front surface with vertical adjustability and to be secured by said front hold down bar under said shelf portion, said support portion including a raised section that extends above said shelf portion, said shelf portion including a pair of spaced, opposed end sections that extend laterally beyond jig base with each said end section having a shelf hold down bar, said shelf portion including a sliding clamp opposite said raised section, said sliding clamp being forwardly and rearwardly adjustable, and having a raised portion that, in combination with said raised section of said support portion and further in conjunction with one of said shelf hold down bars, clamps a mortise workpiece,
a mortise template sized and shaped to mount on said front portion of said top face of said template support between said template guides, and having a pair of spaced elongated mortise template support slots extending parallel to said template guides and located one each over a said template support aperture, and a machine screw extending through each said mortise template support slot into a said template support aperture, said mortise template including a plurality of spaced first mortising slots perpendicular to said mortise template support slots sized to provide two sided guidance of said guide bushing and a plurality of spaced second mortising slots parallel to said mortise template support slots sized to provide two sided guidance of said guide bushing, said first and second mortising slots each having an upwardly opening upper,channel, a downwardly opening lower channel and an intermediate passage connecting said upper and lower channels, and said first and second mortising slots having slidably adjustable movable stops each having an upper piece sized and shaped to fit into a said upper channel, a lower piece sized and shaped to fit into a said lower channel, and a screw connecting said upper and lower pieces,
a tenon template sized and shaped to mount on said front portion of said top face of said template support between said template guides, and having a pair of spaced elongated tenon template support slots extending parallel to said template guides and located one each over a said template support aperture, and a machine screw extending through each said tenon template support slot into a said template support aperture, said tenon template including a plurality of spaced tenoning slots sized to provide two sided guidance of said guide bushing, each said tenoning slot having a laterally extending lateral section and a pair of spaced end sections that extend rearwardly from opposite ends of said lateral section, each said tenoning slot having an upwardly opening upper channel, a downwardly opening lower channel and an intermediate passage connecting said upper and lower channels, said tenoning slots having slidably adjustable movable stops each having an upper piece sized and shaped to fit into a said upper channel, a lower piece sized and shaped to fit into a said lower channel, and a screw connecting said upper and lower pieces, and
a layout guide having a front edge and a plurality of spaced guide lines at selected precise distances from and parallel to said front edge, with said distances being selected as the radius of said guide bushing and the difference between the radius of said guide bushing and the radius of said bit, for different said guide bushing and bit sizes.
